(19) United States
(12) Patent Application Publication
(10) Pub. No.: US 2026/0313392 A1
(43) Pub. Date: Oct. 8, 2026

(54) DYNAMIC COLLISION OF PRE-CONFIGURED MEASUREMENT GAP (PRE-MG)

(71) Applicant: APPLE INC., Cupertino, CA (US)

(72) Inventors: Qiming LI, Bejing (CN); Jie CUI, Cupertino, CA (US); Yang TANG, Cupertino, CA (US); Dawei ZHANG, Cupertino, CA (US); Yuqin CHEN, Bejing (CN); Yuexia SONG, Bejing (CN)

(73) Assignee: APPLE INC., Cupertino, CA (US)

(21) Appl. No.: 19/479,018

(22) PCT Filed: May 10, 2023
(86) PCT No.: PCT/CN2023/093237

§ 371 Date: Oct. 27, 2025

(51) Int. Cl. H04W 24/02; H04W 24/08

(52) U.S. Cl. CPC H04W 24/02; H04W 24/08

(57) ABSTRACT

Aspects are described for a user equipment (UE) comprising a transceiver configured to enable wireless communications with a base station and a processor communicatively coupled to the transceiver. The processor is configured to receive a configuration message from the base station. The configuration message configures the UE with a first measurement gap (MG) and a second MG. The processor is further configured to determine that the first MG and the second MG overlap at least partially in a first time period and measure a first measurement object corresponding to the first MG in the first time period. The first MG is a pre-configured MG. A priority of the first MG is higher than a priority of the second MG.

### BACKGROUND

### Field

The described aspects generally relate to resolving conflicts of measurement gaps (MGs).

### SUMMARY

Some aspects of this disclosure relate to systems, apparatuses, and methods for resolving conflicts of MGs. For example, the systems, the apparatuses, and the methods are provided for prioritizing a MG based on priority levels and/or status of MGs.

Some aspects of this disclosure relate to a user equipment (UE) comprising a transceiver configured to enable wireless communications with a base station and a processor communicatively coupled to the transceiver. The processor is configured to receive a configuration message from the base station. The configuration message configures the UE with a first MG and a second MG. The processor is further configured to determine that the first MG and the second MG overlap at least partially in a first time period and to measure a first measurement object corresponding to the first MG in the first time period. The first MG is a pre-configured MG. A priority of the first MG is higher than a priority of the second MG.

Some aspects of this disclosure relate to a method of operating a UE. The method comprises receiving a configuration message from a base station. The configuration message configures the UE with a first MG and a second MG. The method further comprises determining that the first MG and the second MG overlap at least partially in a first time period and measuring a first measurement object corresponding to the first MG in the first time period. The first MG is a pre-configured MG. A priority of the first MG is higher than a priority of the second MG.

Some aspects of this disclosure relate to a non-transitory computer-readable medium (CRM) comprising instructions to, upon execution of the instructions by one or more processors of a UE, cause the UE to perform operations. The operations comprise receiving a configuration message from a base station. The configuration message configures the UE with a first MG and a second MG. The operations further comprise determining that the first MG and the second MG overlap at least partially in a first time period and measuring a first measurement object corresponding to the first MG in the first time period. The first MG is a pre-configured MG. A priority of the first MG is higher than a priority of the second MG.

This Summary is provided merely for the purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing a measurement gap collision resolution, according to some aspects of the disclosure.

FIG. 2 illustrates a block diagram of an example system of an electronic device for implementing multiple MGs, according to some aspects of the disclosure.

FIG. 3 illustrates an example of multiple MGs, according to aspects of the disclosure.

FIG. 4 illustrates an example of a pre-configured MG, according to aspects of the disclosure.

FIG. 5 illustrates an example of a measurement gap collision resolution, according to aspects of the disclosure.

FIG. 6 illustrates an example method of the measurement gap collision resolution, according to aspects of the disclosure.

FIG. 7 is an example computer system for implementing some aspects of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to systems, apparatuses, and methods for resolving conflicts of MGs. For example, the systems, the apparatuses, and the methods are provided for prioritizing a MG based on priority levels and/or status of MGs.

In some aspects, a UE can monitor channels and surrounding environment by measuring received signals, which can include, but not limited to, channel state information reference signal (CSI-RS), SS block (SSB) signals, SS/PBCH block measurement timing configuration (SMTC), and so on. For example, the UE can measure signals from a base station serving the UE to determine whether a communication link with the base station can satisfy quality of service (QoS) requirements. For another example, the UE can measure signals received from neighboring base stations or neighboring cells to perform a handover procedure. In some aspects, the UE is not able to transmit or receive data when measuring received signals. Thus, measuring signals may interrupt data transmissions, which causes intermittent communication or even call drops. To avoid such QoS degradation, the UE can be configured with a MG. The MG includes predefined time locations for the UE to perform measurements of various signals. In some aspects, the UE is unlikely to perform data transmissions, such as transmitting and receiving data, in the predefined time locations of the MG. For example, the predefined time locations can be a part of the handover procedure. When the UE determines that the signals received from the base station are below a threshold, such as a reference signal received power (RSRP) threshold, the UE can initiate the handover procedure and thus is less likely to perform the data transmissions. In other aspects, the UE may proactively avoid performing the data transmissions in the predetermined time locations and thus unexpected call drops can be avoided. In some aspects, the MG can be a concurrent MG. For example, the UE is configured with multiple operating frequencies for both the measurements and the data transmission in the predefined time locations of the concurrent MG. Thus, the UE can perform the measurement and the data transmission simultaneously in the predefined time locations of the concurrent MG. In summary, by configuring the MG to the UE, the QoS degradation is avoided or reduced.

In some aspects, the UE can be configured with multiple MGs. For example, the UE can be configured with a first MG and a second MG. The first MG can correspond to a first measurement object and the second MG can correspond to a second measurement object. Thus, the UE measures the first measurement object within a first set of time locations of the first MG and measures the second measurement object within a second set of time locations of the second MG. The first and the second sets of time locations may have different characteristics. For example, the first set of time locations have periods of a first length and the second set of time locations have periods of a second length. For another example, the first set of time locations may have a first periodicity and the second set of time locations may have a second periodicity.

In some aspects, the first MG and the second MG may conflict in time. For example, a first time location of the first set and a second time location of the second set may overlap at least partially. However, the UE may only measure one measurement object in the overlapping period, namely, either the first measurement object or the second measurement object. In such a case, the UE can measure the measurement object with a higher priority. For example, the first MG can be assigned with a first priority and the second MG can be assigned with a second priority. Thus, the first measurement object corresponds to the first priority and the second measurement object corresponds to the second priority. If the first priority is higher than the second priority, the UE measures the first measurement object in the overlapping period. Otherwise, the UE measures the second measurement period in the overlapping period.

In some aspects, measurement objects correspond to frequency bands, such as bandwidth parts (BWPs). For example, the first measurement object corresponds to a first BWP and the second measurement object corresponds to a second BWP. Thus, in the first set of time locations, the UE measures the first measurement object in the first BWP and in the second set of time locations, the UE measures the second measurement object in the second BWP. In some aspects, one BWP is active at a given time for the UE. For example, in the first set and the second set of time locations, a third BWP is active. Thus, the UE switches to the first BWP in the first set of time locations to measure the first measurement object and switches to the second BWP in the second set of time locations to measure the second measurement object.

In some aspects, the UE can be configured with a pre-configured MG (Pre-MG). The base station can configure the Pre-MG using radio resource control (RRC) signaling. Furthermore, the base station can activate and deactivate the Pre-MG upon active BWP switching or activation/deactivation of a secondary cell (SCell). Thus, unlike other types of MGs, such as a concurrent MG, which require reconfigurations via the RRC signaling to be disabled or enabled, the Pre-MG can be dynamically controlled without RRC reconfiguration. This is beneficial because BWP switching and activation/deactivation of a SCell can be triggered by downlink control information (DCI) or medium access control (MAC) signaling, which are more time efficient and dynamic than the RRC signaling. For example, the base station can configure the UE with a first Pre-MG in the third BWP. The first Pre-MG corresponds to the first measurement object in the first BWP. When the third BWP is active, the base station can activate the first Pre-MG using the DCI signaling. In such a case, the UE switches to the first BWP to measure the first measurement object in time locations of the first Pre-MG. When the second BWP is active, the base station can deactivate the first Pre-MG using the DCI signaling. In such a case, the UE ignores the first Pre-MG and performs activities in the second BWP. When the first BWP is active, the base station also deactivates the first pre-configuration MG using the DCI signaling. However, because the first measurement object is scheduled to be received at the UE in the time locations of the first Pre-MG in the first BWP, the UE may still measure the first measurement object in the time locations of the first Pre-MG. Thus, the first Pre-MG acts as if is not deactivated if the first BWP is active. In some aspects, the UE may perform both data transmission and measurement in the time locations of the first PRE-MG when the first BWP is originally active, i.e., not switched from another active BWP. In contrast, when the UE switches to the first BWP from the third BWP that is active based on the first Pre-MG, the UE can perform the measurements, but not the data transmission in the time locations of the first Pre-MG.

In some aspects, the UE can be configured with the first Pre-MG and a second MG. The second MG can be a concurrent MG or other types of MG. In some aspects, the first Pre-MG may collide with the second MG in time. For example, a first time location of the first Pre-MG may overlap with a second time location of the second MG at least partially. In such a case, the UE needs to implement one MG and disable the other one. However, the current 3GPP standards and literatures do not provide a solution for the UE to determine which MG to implement and which MG to disable. In some aspects, a priority of the Pre-MG is higher than a priority of the second MG. When the Pre-MG is activated, i.e., the third BWP is active, the UE can perform the Pre-MG by switching to the first BWP and measuring the first measuring object. However, when the third BWP is not active, the Pre-MG can be deactivated and the UE can determine whether to perform the Pre-MG or the second MG based on a further configuration from the base station.

In some aspects, the UE can be configured with the first Pre-MG and a second Pre-MG and they may collide in time. For example, a third time location of the first Pre-MG and a fourth time location of the second Pre-MG may overlap at least partially. In such a case, the UE can determine whether to perform the first Pre-MG or the second Pre-MG based on their respective priorities, statutes, and/or addition configurations from the base station.

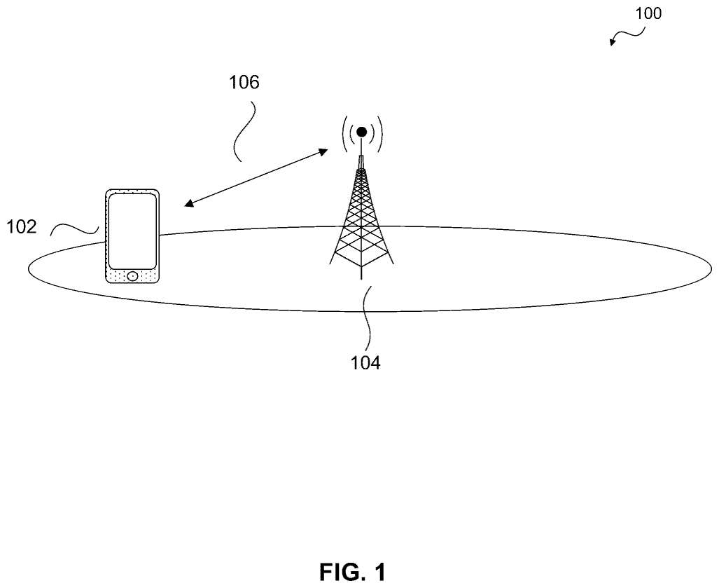

FIG. 1 illustrates an example system 100 implementing a measurement gap collision resolution, according to some aspects of the disclosure. The example system 100 is provided for the purpose of illustration only and does not limit the disclosed aspects. The example system 100 may include, but is not limited to, a UE 102 and a base station 104. The UE 102 may be implemented as electronic devices configured to operate based on a wide variety of wireless communication techniques. These techniques may include, but are not limited to, techniques based on 3rd Generation Partnership Project (3GPP) standards. For example, the UE 102 may be configured to operate using one or more 3GPP releases, such as Release 15 (Rel-15), Release 16 (Rel-16), Release 17 (Rel-17), Release 18 (Rel-18), or other 3GPP releases. The UE 102 may include, but is not limited to, wireless communication devices, smartphones, laptops, desktops, tablets, personal assistants, monitors, televisions, wearable devices, Internet of Things (IOT) devices, vehicle communication devices, and the like. The base station 104 may include one or more nodes configured to operate based on a wide variety of wireless communication techniques such as, but not limited to, techniques based on the 3GPP standards. For example, the base station 104 may include nodes configured to operate using Rel-15, Rel-16, Rel-17, Rel-18, or other 3GPP releases. The base station 104 may include, but not limited to, NodeBs, evolved NodeBs (eNodeBs), next generation NodeBs (gNBs), new radio base stations (NR BSs), access points (APs), remote radio heads, relay stations, transmission/reception points (TRPs), and others.

In some aspects, the UE 102 connects with the base station 104 via a communication link 106. The communication link 106 may correspond to multiple frequency bands, such as multiple BWPs. The UE 102 and the base station 104 can communicate with each other via the multiple BWPs. In some aspects, one BWP is active at a given time. Thus, the UE 102 and the base station 104 switch between BWPs to perform transmissions. For example, the base station 104 can transmit various measurement objects to the UE 102 for the UE 102 to measure. The base station 104 can transmit a first measurement object in a first BWP and transmit a second measurement object in a second BWP. Thus, the UE 102 needs to switch to the first BWP to measure the first measurement object and switch to the second BWP to measure the second measurement object.

In some aspects, the base station 104 can configure the UE 102 with a first MG and a second MG. For example, the base station 104 can generate and transmit a configuration message to the UE 102. The configuration message can indicate the first MG and the second MG. The configuration message can also indicate that the first MG corresponds to the first measurement object in the first BWP and the second MG corresponds to the second measurement object in the second BWP. In time locations of the first MG, the UE 102 can switch to the first BWP and measure the first measurement object. Likewise, in time locations of the second MG, the UE 102 can switch to the second BWP and measure the second measurement object.

In some aspects, the first MG and the second MG may have conflicts in time. In such a case, the UE 102 can resolve the conflicts by performing one MG and disabling the other MG based on various approaches. For example, the UE 102 can resolve the conflicts by priorities of the first and the second MGs. In some aspects, the configuration message can indicate priorities of the first and the second MGs. For another example, one or both of the first MG and the second MG may be Pre-MGs. In such a case, the UE 102 can resolve the conflicts based on whether a Pre-MG is activated. In some aspects, the base station 104 can configure the UE 102 with an approach to resolve the conflict. For example, the configuration message can configure the UE 102 to resolve the conflict by the priorities of the first and the second MGs. The base station 104 can also configure the UE 102 with an approach to resolve the conflict using a second configuration message. In some aspects, the base station 104 can transmit the second configuration message to the UE 102 together with the configuration message or separately from the configuration message.

In some aspects, the UE 102 can report to the base station 104 an approach the UE 102 is capable of performing or prefers to perform. For example, the UE 102 can generate and transmit a capability report to the base station 104. The capability report may indicate an approach to resolve the conflicts. In some aspects, the capability report may indicate a plurality of approaches. In such a case, the base station 104 can select one approach from the plurality of approaches and indicate the selected approach in the configuration message or the second configuration message.

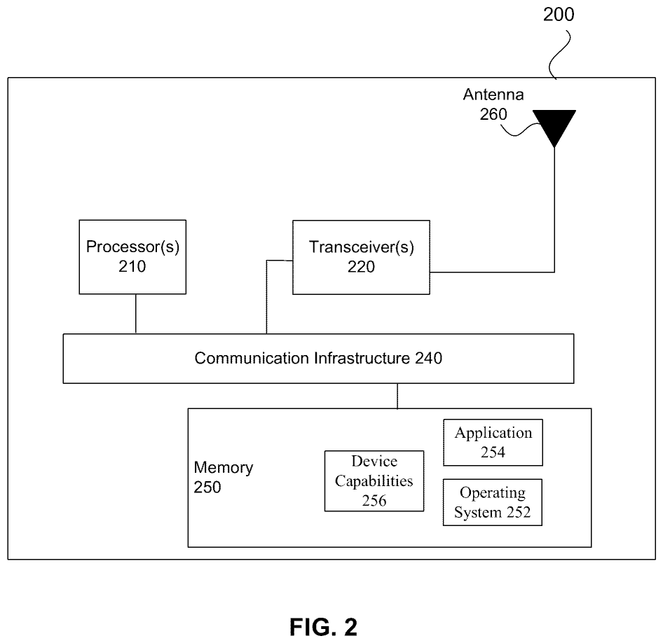

FIG. 2 illustrates a block diagram of an electronic device 200 implementing multiple MGs, according to some aspects of the disclosure. The electronic device 200 may be any of the electronic devices (e.g., the UE 102 and the base station 104) of the system 100. The electronic device 200 includes a processor 210, one or more transceivers 220, a communication infrastructure 240, a memory 250, an operating system 252, an application 254, device capabilities 256, and antennas 260. Illustrated systems are provided as exemplary parts of electronic device 200, and electronic device 200 may include other circuit(s) and subsystem(s). Also, although the systems of electronic device 200 are illustrated as separate components, the aspects of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the one or more transceivers 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the electronic device 200 and/or a user of the electronic device 200. The applications in the application 254 may include applications such as, but not limited to, radio streaming, video streaming, remote control, and/or other user applications. In some aspects, the device capabilities 256 may be stored in the memory 250.

The electronic device 200 may also include the communication infrastructure 240. The communication infrastructure 240 provides communication between, for example, the processor 210, the one or more transceivers 220, and the memory 250. In some implementations, the communication infrastructure 240 may be a bus.

The processor 210, alone, or together with instructions stored in the memory 250 performs operations enabling electronic device 200 of the systems 100 and 200 to implement the MG collision resolution, as described herein. Alternatively, or additionally, the processor 210 can be “hard coded” to implement mechanisms for the MG collision resolution, as described herein.

The one or more transceivers 220 transmit and receive communications signals support mechanisms for the MG collision resolution. Additionally, the one or more transceivers 220 transmit and receive communications signals that support mechanisms for measuring communication link(s), generating and transmitting system information, and receiving the system information. According to some aspects, the one or more transceivers 220 may be coupled to the antennas 260 to wirelessly transmit and receive the communication signals. The antennas 260 may include one or more antennas that may be the same or different types and can form one or more antenna ports. The one or more transceivers 220 allow electronic device 200 to communicate with other devices that may be wired and/or wireless. In some examples, the one or more transceivers 220 may include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some aspects of this disclosure, the one or more transceivers 220 may include a cellular subsystem, a WLAN subsystem, and/or a Bluetooth™ subsystem, each including its own radio transceiver and protocol(s) as will be understood by those skilled in the arts based on the discussion provided herein. In some implementations, the one or more transceivers 220 may include more or fewer systems for communicating with other devices.

In some examples, the one or more the transceivers 220 may include one or more circuits (including a WLAN transceiver) to enable connection(s) and communication over WLAN networks such as, but not limited to, networks based on standards described in IEEE 802.11.

Additionally, or alternatively, the one or more the transceivers 220 may include one or more circuits (including a BluetoothTM transceiver) to enable connection(s) and communication based on, for example, BluetoothTM protocol, the BluetoothTM Low Energy protocol, or the BluetoothTM Low Energy Long Range protocol. For example, the transceiver 220 may include a BluetoothTM transceiver.

Additionally, the one or more the transceivers 220 may include one or more circuits (including a cellular transceiver) for connecting to and communicating on cellular networks. The cellular networks may include, but are not limited to, 3G/4G/5G networks such as Universal Mobile Telecommunications System (UMTS), Long-Term Evolution (LTE), and the like. For example, the one or more transceivers 220 may be configured to operate according to one or more of Rel-15, Rel-16, Rel-17, or other releases of 3GPP standard.

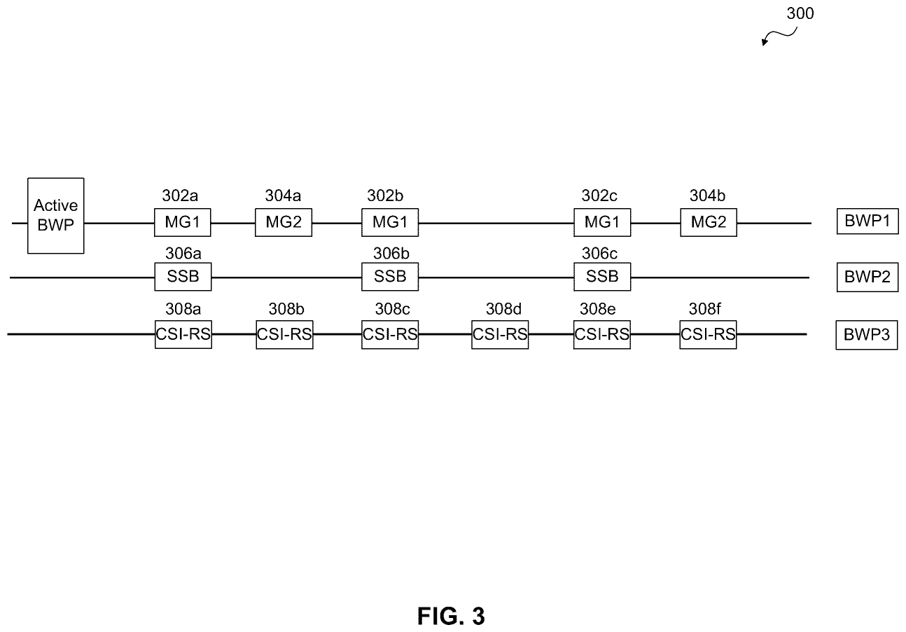

As discussed in more detail below with respect to FIGS. 3-7, processor 210 may implement different mechanisms for the MG collision resolution as discussed with respect to the system 100 of FIG. 1 and the system 200 of FIG. 2.

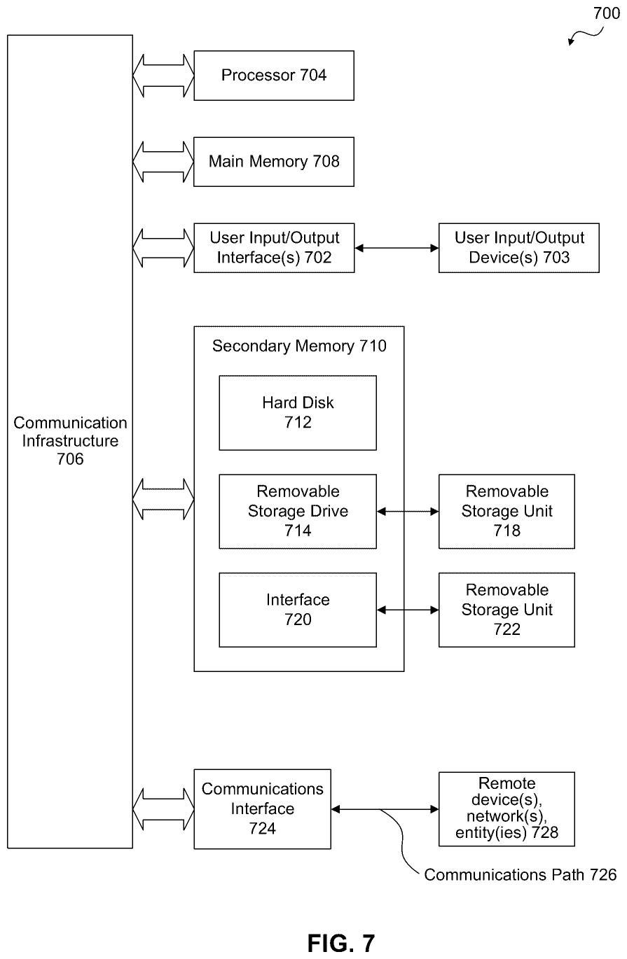

FIG. 3 illustrates an example 300 of multiple MGs, according to aspects of the disclosure. The example 300 is provided for the purpose of illustration only and does not limit the disclosed aspects. As a convenience and not a limitation, FIG. 3 may be described with regard to elements of FIGS. 1, 2, and 7. The example 300 may represent the operation of electronic devices (for example, the UE 102 and the base station 104) implementing the MG collision resolution. The example 300 may also be performed by the electronic device 200 of FIG. 2, controlled or implemented by processor 210, and/or computer system 700 of FIG. 7. But the example 300 is not limited to the specific aspects depicted in those figures and other systems may be used to perform the method, as will be understood by those skilled in the art. It is to be appreciated that not all operations may be needed, and the operations may not be performed in the same order as shown in FIG. 3.

In some aspects, a UE, such as the UE 102 in FIG. 1, is configured with two MGs: MG1 and MG2. Each MG includes a plurality of time locations. For example, referring to FIG. 3, the MG1 includes time locations 302a, 302b, and 302c. Similarly, the MG2 includes time locations 304a and 304b. The time locations of the MG1 and the MG2 may have different characteristics. For example, the time locations 302a, 302b, and 302c can share a first measurement gap length (MGL) and the time locations 304a and 304b can share a second MGL. For another example, the time locations 302a, 302b, and 302c correspond to a first measurement gap repetition period (MGRP), which is a time interval between two consecutive time locations of either MG1 or MG2. Thus, a time interval between the time locations 302a and 302b and a time interval between the time locations 302b and 302c can both be the same, and are referred to as a first MGRP. Here, since the time locations 302a, 302b, and 302c correspond to the first MGRP, the MG1 is periodic. Alternatively, the time locations of the MG1 may correspond to multiple different MGRPs. In such a case, the MG1 is aperiodic. Similarly, the time locations 304a and 304b correspond to a second MGRP. Thus a time interval between the time locations 304a and 304b is the second MGRP. Here, similarly to MG1, MG2 is also periodic or can be aperiodic.

In some aspects, the UE is configured with a plurality of BWPs, including BWP1, BWP2, and BWP3 illustrated in FIG. 3. The MG1 and the MG2 are assigned to BWP1. Thus, if the BWP1 is active in time locations of the MG1 or MG2, the UE can perform measurements during MG1 or MG2. In some aspects, the UE is also configured with measurement objects. For example, the UE is configured with SSB signals in the BWP2 and CSI-RS in the BWP3. Specifically, a base station, such as the base station 104, is configured to transmit the SSB signals in the BWP2 in time locations 306a, 306b, and 306c. Similarly, the base station is configured to transmit the CSI-RS in the BWP3 in time locations 308a, 308b, 308c, 308d, 308e, and 308f. As discussed above, the measurement objects, such as the SSB signals and the CSI-RS, can be used by the UE to measure signal strengths, channel conditions, interference levels, and so on. However, as shown in FIG. 3, the BWP1 is active in the time locations 306a, 306b, 306c, 308a, 308b, 308c, 308d, 308e, and 308f and thus the UE is not able to measure the SSB signals and CSI-RS. In some aspects, the UE can switch BWP in time locations of MGs. Specifically, one measurement object can correspond to one MG. For example, the SSB signals can be aligned in time with the MG1 and the CSI-RS can be aligned in time with the MG2. In such a case, in the time locations of the MG1 and the MG2, the UE can switch to the BWP2 or the BWP3 to perform measurements. For example, in the time locations 302a, 302b, and 302c that correspond to MG1, the UE can switch from the BWP1 to the BWP2 to measure the SSB signals. Here, the time locations 302a, 302b, and 302c overlap or include the time locations 306a, 306b, and 306c that correspond to SSB transmissions from the base station. For another example, in the time location 304a and 304b, the UE can switch from the BWP1 to the BWP3 to measure the CSI-RS. Here, the time locations 304a and 304b overlap or include the time locations 308b and 308f that correspond to CSI-RS transmissions from the base station. In some aspects, multiple measurement objects may be transmitted by the base station in a time period. For example, the base station transmits the SSB signals in the time location 306a via BWP2 and transmits the CSI-RS in the time location 308a via BWP3, wherein the time locations 306a and 308a overlap at least partially. As explained above, because the MG1 corresponds to the SSB signals, the UE switches to the BWP2 and measures the SSB signals in the time location 302a. Because there is no time location of the MG2 that covers the time location 308a, the UE cannot measure the CSI-RS in the time location 308a. In some aspects, a time location of a measurement object may not be covered by any MG. For example, the time location 308d is not covered by any time locations of the MG2. In such a case, the UE does not switch to the BWP3 in the time location 308d and the CSI-RS is not measured.

In some aspects, MGs can correspond to all BWPs. For example, the MG1 and the MG2 can correspond to the BWP1, the BWP2, and the BWP3. Thus, the UE can switch regardless of which BWP is active. For example, assuming that the BWP2 is active all the time instead of the BWP1, the UE can switch to the BWP3 in the time locations 308d and 308f to measure the CSI-RS. For another example, the BWP1, the BWP2, and the BWP3 can take turns to be active. In such a case, no matter which BWP is active, the UE switch or stay on a BWP based on time locations of the MG1 and MG2. For example, the UE can switch to or stay on the BWP2 in the time location 302a to measure the SSB signals regardless of the active BWP.

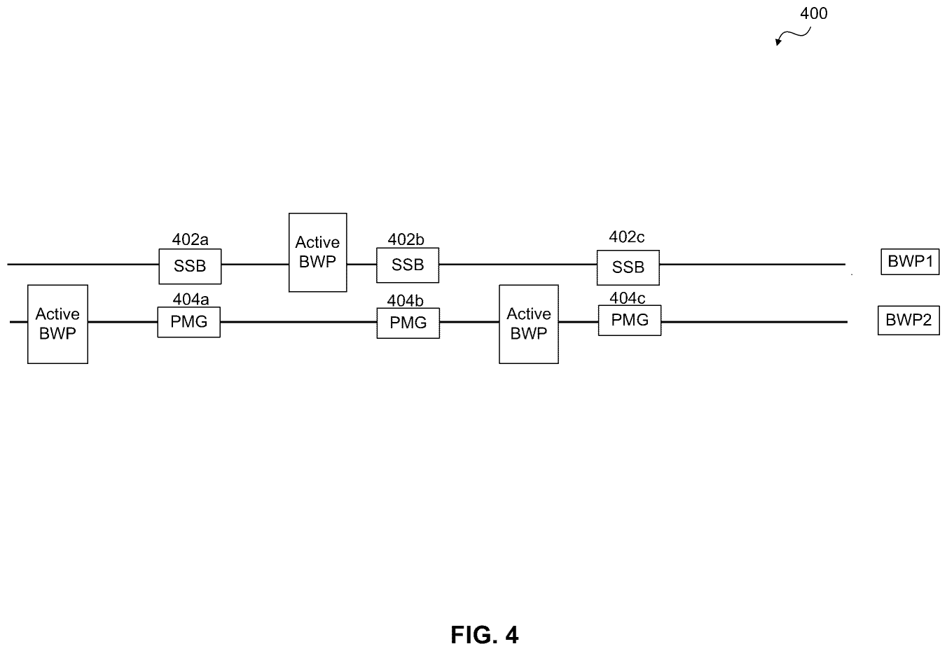

FIG. 4 illustrates an example 400 of a Pre-MG, according to aspects of the disclosure. The example 400 is provided for the purpose of illustration only and does not limit the disclosed aspects. As a convenience and not a limitation, FIG. 4 may be described with regard to elements of FIGS. 1, 2, and 7. The example 400 may represent the operation of electronic devices (for example, the UE 102 and the base station 104) implementing the Pre-MG. The example 400 may also be performed by the electronic device 200 of FIG. 2, controlled or implemented by processor 210, and/or computer system 700 of FIG. 7. But the example 400 is not limited to the specific aspects depicted in those figures and other systems may be used to perform the method, as will be understood by those skilled in the art. It is to be appreciated that not all operations may be needed, and the operations may not be performed in the same order as shown in FIG. 4.

In some aspects, a UE, such as the UE 102 in FIG. 1, is configured with a Pre-MG in BWP2. The Pre-MG corresponds to SSB signals in BWP1 and includes time locations 404a, 404b, and 404c. In some aspects, a base station, such as the base station 104 in FIG. 1, can configure the Pre-MG using RRC signaling. The RRC signaling can include a configuration message that indicates the Pre-MG, the corresponding BWP2, and/or the time locations 404a, 404b, and 404c. As shown in FIG. 4, the BWP2 is active prior to the time location 404a. In some aspects, the base station can activate the Pre-MG a predefined period prior to the time location 404a or when the BWP2 becomes active. For example, the base station can transmit an activation signal via a DCI signaling when the BWP2 becomes active. The base station can also transmit the activation signal via the DCI signaling a short period prior to the time location 404a, such as 20 ms prior to the time location 404a. Thus, the Pre-MG can be dynamically activated. When the Pre-MG is activated, the UE can switch to the BWP1 in the time location 404a to measure the SSB signals. As shown here, the base station transmits the SSB signals in a time location 402a, which is aligned with the time location 404a.

In some aspects, the UE can switch the active BWP. For example, the BWP1 can become active after the time location 404a and before the time location 404b. Similar to activating the Pre-MG, the base station can deactivate the Pre-MG when the BWP1 becomes active and the BWP2 becomes inactive. The base station can transmit a deactivation signal via the DCI signaling to the UE to deactivate the Pre-MG when the BWP1 becomes active. The base station can also transmit the deactivation signal a predefined period prior to a following time location of the Pre-MG, e.g., the time location 404b in FIG. 4. In such a case, because the Pre-MG is inactive, the UE does not switch BWP based on the Pre-MG. Here, the BWP1 is active in a time location 402b when the SSB signals are transmitted by the base station. Thus, the UE can measure the SSB signals in the BWP1 without switching BWP. However, if BWP1 and BWP2 are both inactive in the time location 402b, the UE is not able to measure the SSB in the time location 402b because the Pre-MG is deactivated and thus the UE is not able to switch to the BWP1 based on the Pre-MG. In some aspects, the UE can switch back to the BWP2 after the time location 404b and before the time location 404c. Similar to the discussion above, the base station can activate the Pre-MG when the BWP2 becomes active or a predefined period before the time location 404c. In such a case, the UE can switch to the BWP1 before the time location 404c to measure the SSB signals. Here, the time location 404c is aligned when the base station transmits the SSB signals to the UE in the BWP1.

In some aspects, the base station activates and deactivate the Pre-MG by activating and deactivating a corresponding BWP. For example, the base station can transmit an activation message to the UE prior to the time location 404a. The activation message activates the BWP2 at the UE. Because the Pre-MG corresponds to the BWP2, the Pre-MG is activated when the BWP2 is active. Phrased differently, the activation message can activate the Pre-MG indirectly. Similarly, the base station can transmit a deactivation message to the UE to deactivate the BWP2 after the time location 404a.

When the BWP2 becomes inactive, the Pre-MG is also deactivated. In some aspects, the base station can also deactivate the BWP2 by activating the BWP1 because one BWP can be active at the UE at a given time. In such a case, when the BWP1 become active, the BWP2 becomes inactive and the Pre-MG is deactivated.

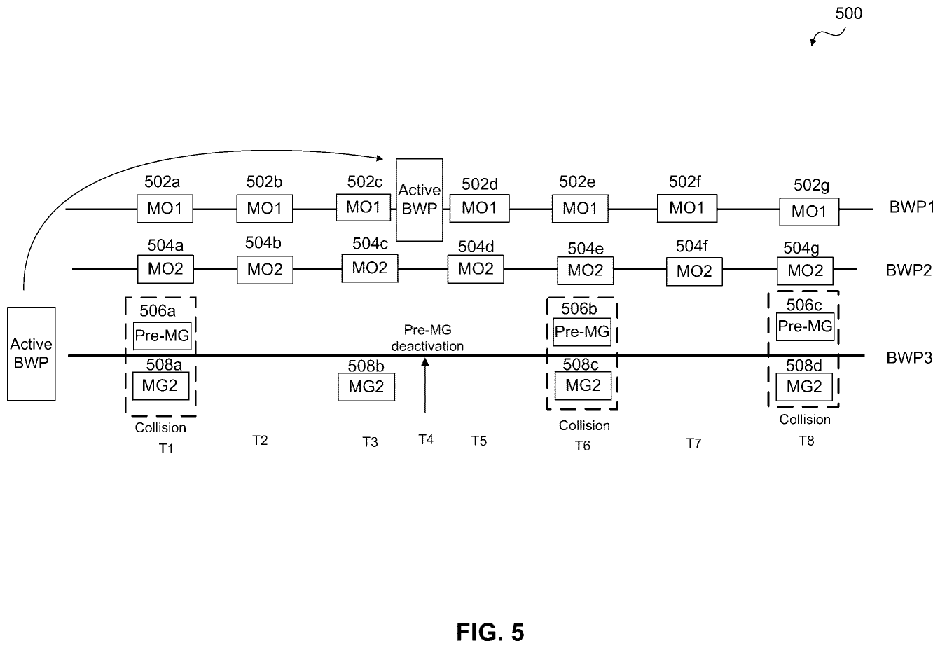

FIG. 5 illustrates an example 500 of a measurement gap collision resolution, according to aspects of the disclosure. The example 500 is provided for the purpose of illustration only and does not limit the disclosed aspects. As a convenience and not a limitation, FIG. 5 may be described with regard to elements of FIGS. 1, 2, and 7. The example 500 may represent the operation of electronic devices (for example, the UE 102 and the base station 104) implementing the measurement gap collision resolution. The example 500 may also be performed by the electronic device 200 of FIG. 2, controlled or implemented by processor 210, and/or computer system 700 of FIG. 7. But the example 500 is not limited to the specific aspects depicted in those figures and other systems may be used to perform the method, as will be understood by those skilled in the art. It is to be appreciated that not all operations may be needed, and the operations may not be performed in the same order as shown in FIG. 5.

In some aspects, a UE, such as the UE 102 in FIG. 1, is configured with a Pre-MG in BWP3 and a MG2. For example, the base station transmits a configuration message to the UE that indicates the Pre-MG and the MG2. The MG2 can be a concurrent MG and other types of MGs. In some aspects, the Pre-MG corresponds to a first measurement object MO1 and the MG2 corresponds to a second measurement object MO2. The MO1 and the MO2 can be SSB signals, SMTC signals, CSI-RS or other types of reference signals, The configuration message can also indicate as such. In some aspects, the base station, such as the base station 104 in FIG. 1, transmits MO1 signals in time locations 502a, 502b, 502c, 502d, 502e, 502f, and 502g in BWP1. The base station also transmits MO2 signals in time location 504a, 504b, 504c, 504d, 504e, 504f, and 504g in BWP2.

The UE can measure the MO1 signals and the MO2 signals based on the Pre-MG and/or the MG2. For example, in a time location 508b, the BWP3 is currently active, so the UE switches to the BWP2 to measure the MO2 signals based on the MG2. In addition, the MG2 can correspond to all BWPs as discussed in FIG. 3. For example, in the time location 508b, the UE switches to the BWP2 to measure the MO2 signals regardless of the active BWP. Specifically, if the BWP1 is active in the time location 508a unlike FIG. 5 illustrates, the UE still switches to the BWP2 in the time location 508b to measure the MO2 signals. Phrased differently, the MG2 can be configured in all BWPs, not just the BWP3. In some aspects, the Pre-MG and the MG2 may collide in time. For example, the Pre-MG is configured in a time location 506a and the MG2 is configured in a time location 508a. The time location 506a and the time location 508a overlap at least partially, which creates a MG collision. Here the Pre-MG is activated in the time location 506a because the BWP3 is active. The UE needs to determine which MG (Pre-MG or MG2) has priority. In some aspects, the Pre-MG and the MG2 correspond to their respective priorities. For example, the Pre-MG can have a first priority and the MG2 can have a second priority. If the first priority is higher than the second priority, the UE switches to the BWP1 to measure the MO1 signals in the BWP1 in the time location 506a. If the second priority is higher than the first priority, the UE switches to the BWP2 to measure the MO2 signals in the BWP2 in the time location 508a.

In some aspects, the UE can switch the active BWP. As shown in FIG. 5, the BWP1 becomes the active BWP after the time location 502c, which is around a time T4. Thus, the base station can deactivate the Pre-MG when the BWP1 becomes active or a predefined period prior to a time location 506b because the Pre-MG corresponds to the BWP3, which becomes inactive when the BWP1 becomes active. Here, the Pre-MG again collides with the MG2 around time T6. Specifically, the time location 506b and a time location 508c overlap at least partially. The UE again needs to determine which MG (Pre-MG or MG2) has priority. The difference between the collision around the time T6 and the collision around time T1 is that the Pre-MG is deactivated around the time T6. Thus, the UE is not able to perform the Pre-MG in the time location 506b. In contrast, since the MG2 corresponds to all BWPs, the UE can still perform the MG2 by switching to the BWP2 and measuring the MO2 in the time location 508c. If the UE switches to the BWP3, the UE cannot measure the MOI signals in the BWP1 in the time location 502e. Thus, although the Pre-MG is deactivated, the UE still needs to determine which MO to measure: the MO1 or the MO2. In some aspects, the base station can transmit one of two types of configurations to the UE. Based on a first type configuration, the UE stays on the BWP1 and measure the MO1 signals in the time location 506b. In such a case, the MG2 is disabled in the time location 508c even though the Pre-MG is deactivated. Based on a second type configuration, the UE switches to the BWP2 to measure the MO2 signals. In such a case, the UE ignores the Pre-MG in the time location 506b because the Pre-MG is deactivated. As illustrated in FIG. 5, the Pre-MG and the MG2 also collide around time T8. Because the BWP1 is still active, the UE performs similarly to the time T6 as discussed above.

In some aspects, the MG2 is also a Pre-MG. In such a case, the MG2 corresponds to a BWP, such as the BWP3, and does not correspond to all BWPs. In some aspects, the Pre-MG and the MG2 can be both activated or deactivated in a time location. For example, around time T1, both the Pre-MG and the MG2 are activated because the BWP3 is active. Around the times T6 and T8, both the Pre-MG and the MG2 are deactivated because the BWP1 is active. In such a case, the UE can determine which MG to perform based on priorities and/or statuses of MGs. For example, around the time T1, the Pre-MG collides with the MG2. As discussed above, the first priority of the Pre-MG is higher than the second priority of the MG2. Thus, the UE switches to the BWP1 to measure the MO1 signals in the time location 506a. For another example, around the time T6 and T8, both the Pre-MG and the MG2 are deactivated. In such a case, the base station can configure the UE with one of two types of approaches. In a type 1 approach, the UE can stay on the BWP1 and measure the MO1 signals in the time locations 506b and 506c because the first priority of the Pre-MG is higher than the second priority of the MG2. In some aspects, unlike illustrated in FIG. 5, another BWP, such as a BWP4 not shown here, is active around the time T6 and T8. Thus, the UE cannot measure the MO1 signals or the MO2 signals if the UE does not switch BWP. In such a case, the UE can switch to the BWP1 to measure the MO1 signals in the time locations 506b and 506c even though the Pre-MG is deactivated. Phrased differently, the UE can perform the Pre-MG as the Pre-MG is activated around the time T6 and T8 because the first priority of the Pre-MG is higher than the second priority of the MG2. In a type 2 approach, the UE can take turns to perform the Pre-MG and the MG2 when they are both deactivated and collide. For example, around the time T6 and T8, both the Pre-MG and the MG2 are deactivated because the BWP1 is active. The UE can stay on the BWP1 in the time location 506b to measure the MO1 signals and switch to the BWP2 in the time location 508d to measure the MO2 signals. In some aspects, another BWP, such as the BWP4 not shown here, is active around the time T6 and T8. The UE can still take turns to perform the Pre-MG and the MG2. Specifically, the UE can switch to the BWP1 in the time location 506b to measure the MO1 signals and switch to the BWP2 in the time location 508d to measure the MO2 signals. In some aspects, the base station indicates a type of approach for the UE to perform in the configuration message transmitted to the UE.

In some aspects, the Pre-MG may be deactivated and the MG2, which is a Pre-MG as discussed above, may be activated in a time location. In such a case, the base station can configure the UE with one of two types of approaches. In a type 1 approach, the UE can switch to or stay on the BWP1 to measure the MOI signals in the time location because the first priority of the Pre-MG is higher than the second priority of the MG2. Thus, a MG with a higher priority always trumps a MG with a lower priority regardless of whether the MG with the higher priority is activated. In a type 2 approach, the UE can switch to the BWP2 to measure the MO2 signals in the time location because the MG2 is activated and the Pre-MG is deactivated. In some aspects, the base station indicates a type of approach for the UE to perform in the configuration message transmitted to the UE.

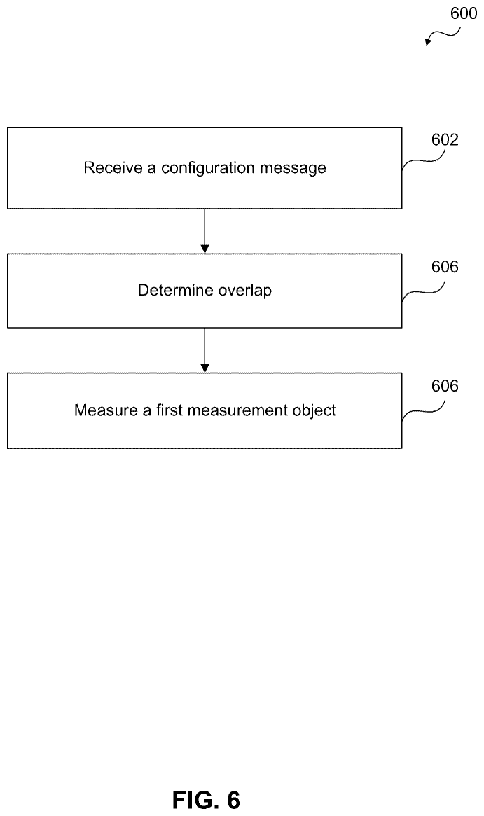

FIG. 6 illustrates an example method 600 of the measurement gap collision resolution, according to aspects of the disclosure. The example method 600 is provided for the purpose of illustration only and does not limit the disclosed aspects. As a convenience and not a limitation, FIG. 6 may be described with regard to elements of FIGS. 1, 2, and 7. The example method 600 may represent the operation of electronic devices (for example, the UE 102 and the base station 104) implementing the measurement gap collision resolution. The example method 600 may also be performed by the electronic device 200 of FIG. 2, controlled or implemented by processor 210, and/or computer system 700 of FIG. 7. But the example method 600 is not limited to the specific aspects depicted in those figures and other systems may be used to perform the method, as will be understood by those skilled in the art. It is to be appreciated that not all operations may be needed, and the operations may not be performed in the same order as shown in FIG. 6.

At 602, a UE, such as the UE 102 in FIG. 1, receives a configuration message from a base station, such as the base station 104 in FIG. 1. In some aspects, the configuration message configures the UE with a first MG and a second MG. The configuration message can also indicate that the first MG is a Pre-MG and corresponds to a first priority. Furthermore, the configuration message can indicate that the second MG is a Pre-MG, a concurrent MG, or other types of MG. Finally, the configuration message can indicate that the second MG corresponds to a second priority that is lower than the first priority.

At 606, the UE determines that the first MG and the second MG overlap at least partially in a first time period.

At 608, the UE measures a first measurement object corresponding to the first MG in the first time period. In some aspects, the first MG is inactive in the first time period and the second MG is a concurrent MG. The UE can perform the first MG based on the configuration message as similarly discussed in FIG. 5. In other aspects, the second MG is also a Pre-MG.

Various aspects can be implemented, for example, using one or more computer systems, such as computer system 700 shown in FIG. 7. Computer system 700 can be any well-known computer capable of performing the functions described herein such as the UE 102 and the base station 104 of FIG. 1. Computer system 700 includes one or more processors (also called central processing units, or CPUs), such as a processor 704.

Processor 704 is connected to a communication infrastructure 706 (e.g., a bus). Computer system 700 also includes user input/output device(s) 703, such as monitors, keyboards, pointing devices, etc., that communicate with communication infrastructure 706 through user input/output interface(s) 702. Computer system 700 also includes a main or primary memory 708, such as random access memory (RAM). Main memory 708 may include one or more levels of cache. Main memory 708 has stored therein control logic (e.g., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 718 in a well-known manner.

According to some aspects, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of LANs, WANs, the Internet, etc. Control logic and/or data may be transmitted to and from computer system 700 via communication path 726.

The operations in the preceding aspects may be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 700, main memory 708, secondary memory 710 and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 7. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE) comprising:
a transceiver configured to enable wireless communications with a base station; and
a processor, communicatively coupled to the transceiver, and configured to:
receive, using the transceiver, a configuration message from the base station, wherein the configuration message configures the UE with a first measurement gap (MG) and a second MG;
determine that the first MG and the second MG overlap at least partially in a first time period; and
measure a first measurement object corresponding to the first MG in the first time period;
wherein the first MG is a pre-configured MG, and
wherein a priority of the first MG is higher than a priority of the second MG.

2. The UE of claim 1,
wherein the first MG is inactive in the first time period, and
wherein the second MG is a concurrent MG.

3. The UE of claim 1, wherein the processor is further configured to measure the first measurement object corresponding to the first MG in the first time period based on the configuration message or a second configuration message received from the base station.

4. The UE of claim 1, wherein the second MG is a second pre-configured MG.

5. The UE of claim 4, wherein the first MG and the second MG are active in the first time period.

6. The UE of claim 4,
wherein the first MG is active in the first time period, and
wherein the second MG is inactive in the first time period.

7. The UE of claim 4, wherein the first MG and the second MG are inactive in the first time period.

8. The UE of claim 7, wherein the processor is further configured to:
determine that the first MG and the second MG overlap in a second time period preceding the first time period; and
measure a second measurement object corresponding to the second MG in the second time period.

9. A method of a user equipment (UE) comprising:
receiving a configuration message from a base station, wherein the configuration message configures the UE with a first measurement gap (MG) and a second MG;
determining that the first MG and the second MG overlap at least partially in a first time period; and
measuring a first measurement object corresponding to the first MG in the first time period;
wherein the first MG is a pre-configured MG, and
wherein a priority of the first MG is higher than a priority of the second MG.

10. The method of claim 9,
wherein the first MG is inactive in the first time period, and
wherein the second MG is a concurrent MG.

11. The method of claim 9, further comprising measuring the first measurement object corresponding to the first MG in the first time period based on the configuration message or a second configuration message received from the base station.

12. The method of claim 9, wherein the second MG is a second pre-configured MG.

13. The method of claim 12, wherein the first MG and the second MG are active in the first time period.

14. The method of claim 12,
wherein the first MG is active in the first time period, and
wherein the second MG is inactive in the first time period.

15. The method of claim 12, wherein the first MG and the second MG are inactive in the first time period.

16. The method of claim 15, further comprising:
determining that the first MG and the second MG overlap at least partially in a second time period preceding the first time period; and
measuring a second measurement object corresponding to the second MG in the second time period.

17. A non-transitory computer-readable medium (CRM) comprising instructions to, upon execution of the instructions by one or more processors of a user equipment (UE), cause the UE to perform operations, the operations comprising:
receiving a configuration message from a base station, wherein the configuration message configures the UE with a first measurement gap (MG) and a second MG;
determining that the first MG and the second MG overlap at least partially in a first time period; and
measuring a first measurement object corresponding to the first MG in the first time period;
wherein the first MG is a pre-configured MG, and
wherein a priority of the first MG is higher than a priority of the second MG.

18. The non-transitory CRM of claim 17,
wherein the first MG is inactive in the first time period, and
wherein the second MG is a concurrent MG.

19. The non-transitory CRM of claim 17,
wherein the second MG is a second pre-configured MG.
wherein the first MG and the second MG are active in the first time period.

20. The non-transitory CRM of claim 17, wherein the operations further comprise:
determining that the first MG and the second MG overlap at least partially in a second time period preceding the first time period; and
measuring a second measurement object corresponding to the second MG in the second time period,
wherein the second MG is a second pre-configured MG, and
wherein the first MG and the second MG are inactive in the first time period.
